(19) United States
(12) Patent Application Publication
(10) Pub. No.: US 2016/0188814 A1
(43) Pub. Date: Jun. 30, 2016

(54) MODELING OF PATIENT RISK FACTORS AT DISCHARGE

(71) Applicant: KONINKLIJKE PHILIPS N.V., Eindhoven (NL)

(72) Inventors: Ushanandini RAGHAVAN, Lexington, MA (US); Saeed Reza Bagheri, Croton on Hudson, NY (US)

(21) Appl. No.: 14/909,761

(22) PCT Filed: Aug. 13, 2014
(86) PCT No.: PCT/IB2014/063892

§ 371 Date: Feb. 3, 2016

Related U.S. Application Data
(60) Provisional application No. 61/865,762, filed on Aug. 14, 2013.

(51) Int. Cl. G06F 19/00; G06N 5/04; G06N 99/00

(52) U.S. Cl. CPC G06F 19/327; G06N 99/005; G06N 5/04

(57) ABSTRACT

A medical system includes a modeling unit (10) which generates a plurality of tree structured classifiers based on a collection of demographic, socio-econometric, diagnoses, procedure, hospital, and logistical data elements, learns patient discharge risk factors based on the plurality of tree structured classifiers and data corresponding to prior patient discharges, and creates a predictive model of readmission based on the learned patient discharge risk factors which scores the identified patient discharge risk factors for one or more patient discharges.

The following relates generally to medical systems. It finds particular application in conjunction with making patient discharge decisions, formulating hospital discharge strategies, and will be described with particular reference thereto. However, it will be understood that it also finds application in other usage scenarios and is not necessarily limited to the aforementioned application.

Hospital in-patient services are a major component of healthcare services consumed which can include significant expenses. Avoiding a hospital readmission after a patient is discharged can result in significant cost savings. Currently 17.6% of acute care admissions results in readmission after discharge and account for $15B in spending. Medical service providers receive financial incentives from reimbursement providers such as Medicare and Medicaid which include penalties for readmissions that exceed certain thresholds. For example, in September 2012 the Centers for Medicare and Medicaid Services began reporting of readmission measures for acute myocardial infarction (AMI), chronic heart failure (CHF), and pneumonia (PN) and penalizing hospitals with a 1% reduction in reimbursement for all admissions in a year with a poor readmission rate.

Hospitals lack models which allow a healthcare practitioner to determine a likelihood of readmission for a patient at discharge. Responses are not identified or are not actionable. For example, knowing that any patient at discharge may be readmitted does not provide any benchmark to indicate whether the patient should be discharged or if not discharged then what alternative to discharging the patient. For example, a hospital with a high readmission rate for pneumonia and incurring a penalty for readmission, and a patient to be discharged who had a diagnosis of pneumonia, does not inform the hospital what to do differently.

The financial penalties apply to annual threshold values and entire patient populations, and do not equip a hospital to determine for a patient to be discharged, a course of action which will avoid readmission for the patient. Furthermore current models do not account for current practices of each hospital, which in certain areas may include rates better than the entire patient population. Applicability to a particular hospital remains unclear. For example, a hospital which incurs a high readmission rate overall, but a low admission rate for patients discharged diagnosed with pneumonia does not inform the hospital what to do differently.

One approach is to create static models such as linear regression models and/or analysis of variance models which select a set of strong predictors based on analysis of a large population. The models are fixed and reported in the literature and the hospital is left to reconcile the model with actual practice. The static models do not consider weak predictors, variability of individual hospital practices, or recommendations for improvement. The models are static and fixed. Moreover the models typically focus on one condition and a fixed set of criteria at a point in time in a general patient population. Root causes for readmission are not clearly understood. There are currently no standards or benchmarks available for hospital to identify patients at high risk for readmission. There are many possible variables which can contribute to a risk of readmission.

The literature conflictingly suggests many possibilities which may include demographic, socio-econometric, diagnostic, procedure, hospital and logistical factors. The factors may include hundreds of variables. Current models do not consider the interactions between the demographic, socio-econometric, diagnostic, procedure, hospital and logical factors encountered by each hospital. Current approaches do not adapt as new information becomes available. Current approaches do not adapt to the financial incentives involved, which may change. Current approaches do not facilitate development of hospital strategies to address readmission rates. The financial incentives include penalties, but do not include any mechanism to identify factors affecting quality of patient care or to develop actionable recommendations, and do not include design strategies for hospitals to improve quality of care or how to allocate resources appropriately.

The following discloses a new and improved modeling of patient risk factors at discharge which addresses the above referenced issues, and others.

In accordance with one aspect, a medical system includes a modeling unit which generates a plurality of tree structured classifiers based on a collection of demographic, socio-econometric, diagnoses, procedure, hospital, and logistical data elements, learns patient discharge risk factors based on the plurality of tree structured classifiers and data corresponding to prior patient discharges, and creates a predictive model of readmission based on the learned patient discharge risk factors which scores the identified patient discharge risk factors for one or more patient discharges.

In accordance with another aspect, a method of processing medical patient information includes generating a plurality of tree structured classifiers based on a collection of demographic, socio-econometric, diagnoses, procedure, hospital, and logistical data elements. Patient discharge risk factors are learned based on the plurality of tree structured classifiers and data corresponding to prior patient discharges. A predictive model of readmission is created which scores the identified patient discharge risk factors for one or more patient discharges based on the learned patient discharge risk factors.

In accordance with another aspect, a medical system includes a patient risk scoring unit which scores a patient for risk of readmission based on a predictive model of readmission which trains a random forest model on a collection of demographic, socio-econometric, diagnoses, procedure, hospital, and logistical data elements and data of prior patient discharges, and the predictive model identifies at least one set of risk factors from the collection predictive of the likelihood of patient readmission. The medical system further includes a display device which displays the identified at least one set of risk factors from the collective scored for the patient risk of readmission.

One advantage resides in a model which predicts risk of readmission for a patient.

Another advantage resides in a model which consideration of hundreds of possible predictors.

Another advantage resides in a model which adapts to different patient populations.

Another advantage resides in a mechanism to identify factors affecting readmission for a hospital.

Another advantage resides in actionable recommendations which include alternatives to patient discharge and are based on hospital performance.

Still further advantages will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

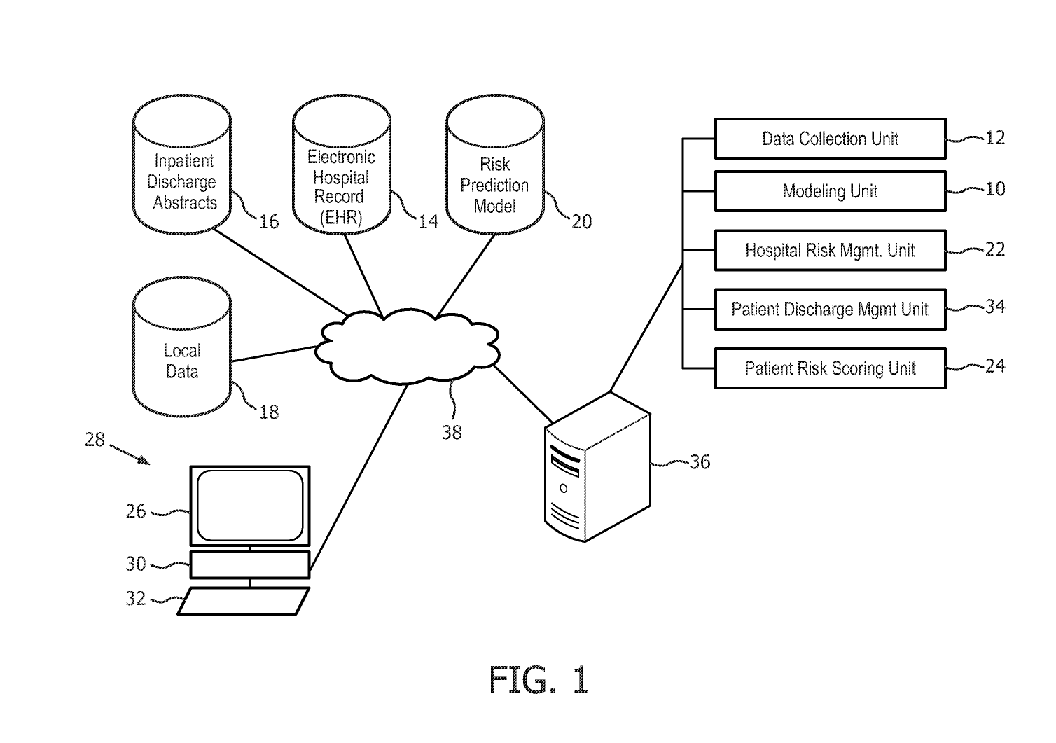

FIG. 1 schematically illustrates an embodiment of a system modeling of patient risk factors at discharge.

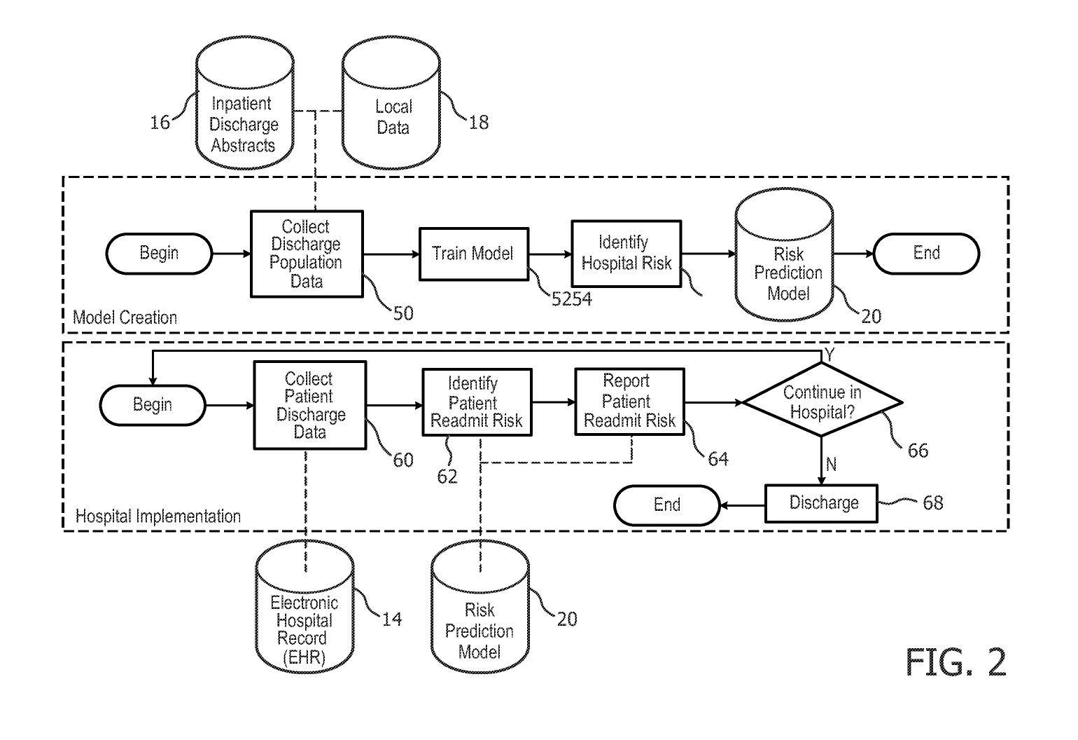

FIG. 2 flowcharts one embodiment of modeling patient risk factors at discharge.

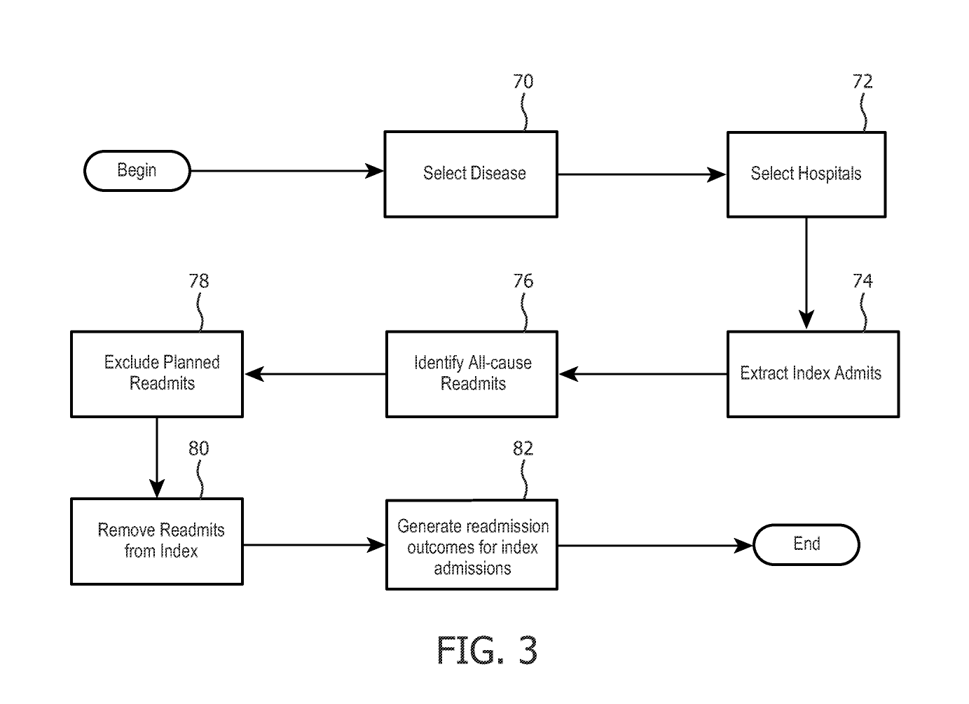

FIG. 3 flowcharts one embodiment of modeling patient risk factors at discharge collecting patient discharge population data.

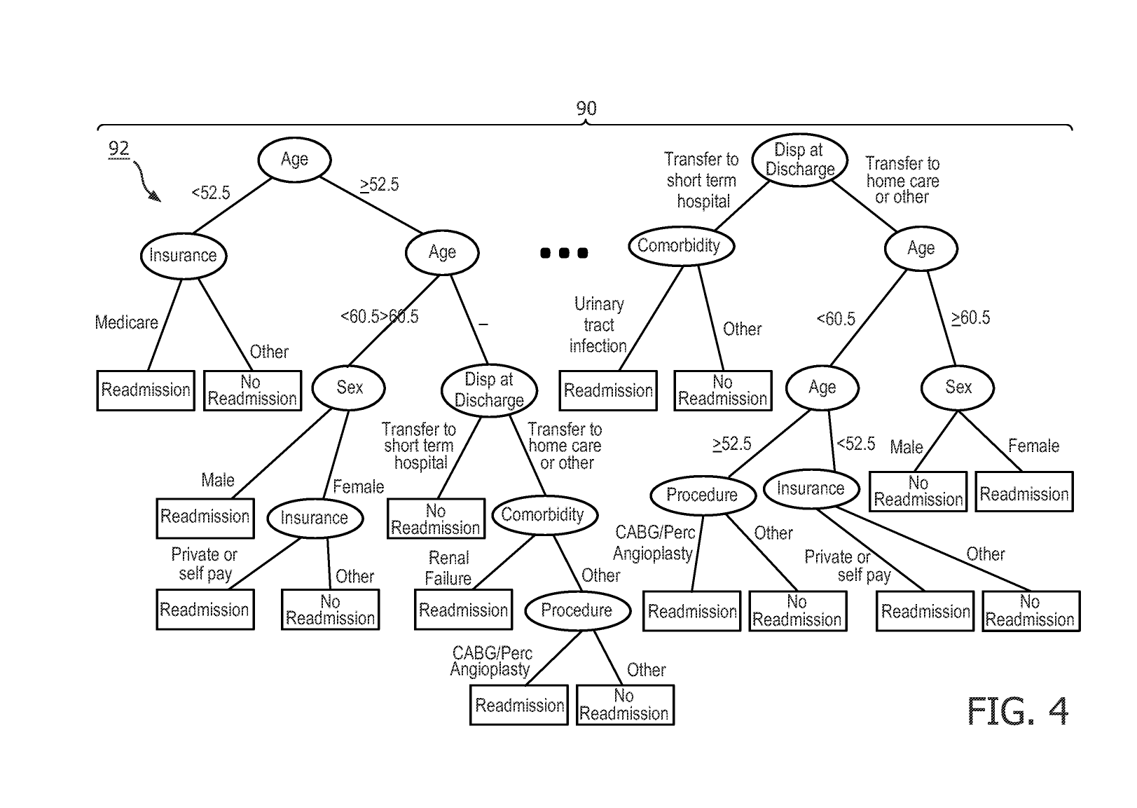

FIG. 4 diagrammatically illustrates exemplary predictor classification decision trees.

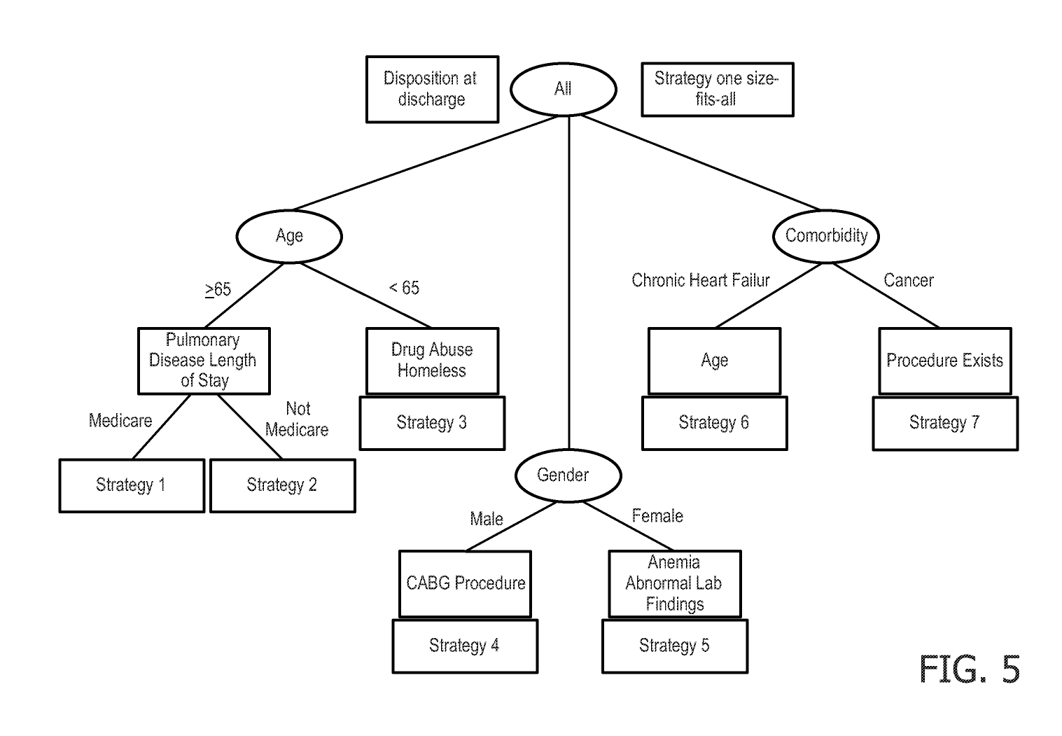

FIG. 5 diagrammatically illustrates an exemplary hospital risk stratification.

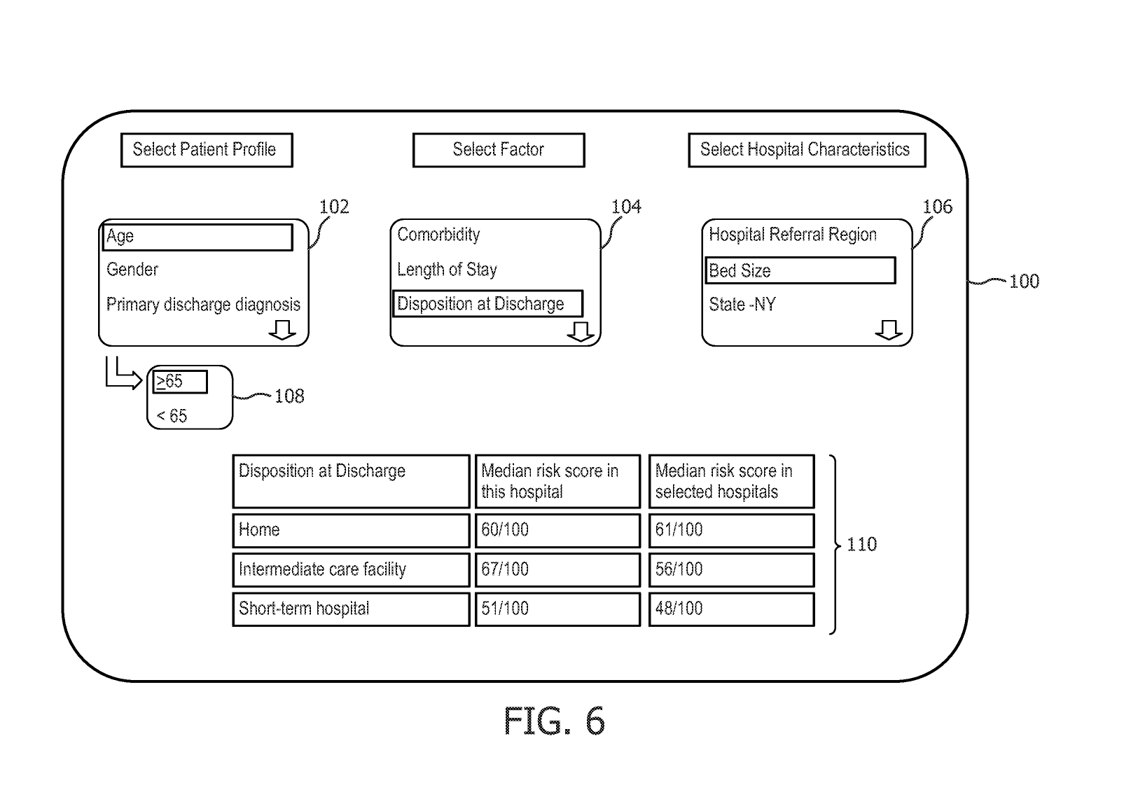

FIG. 6 diagrammatically illustrates an exemplary hospital risk strategy decision support tool display.

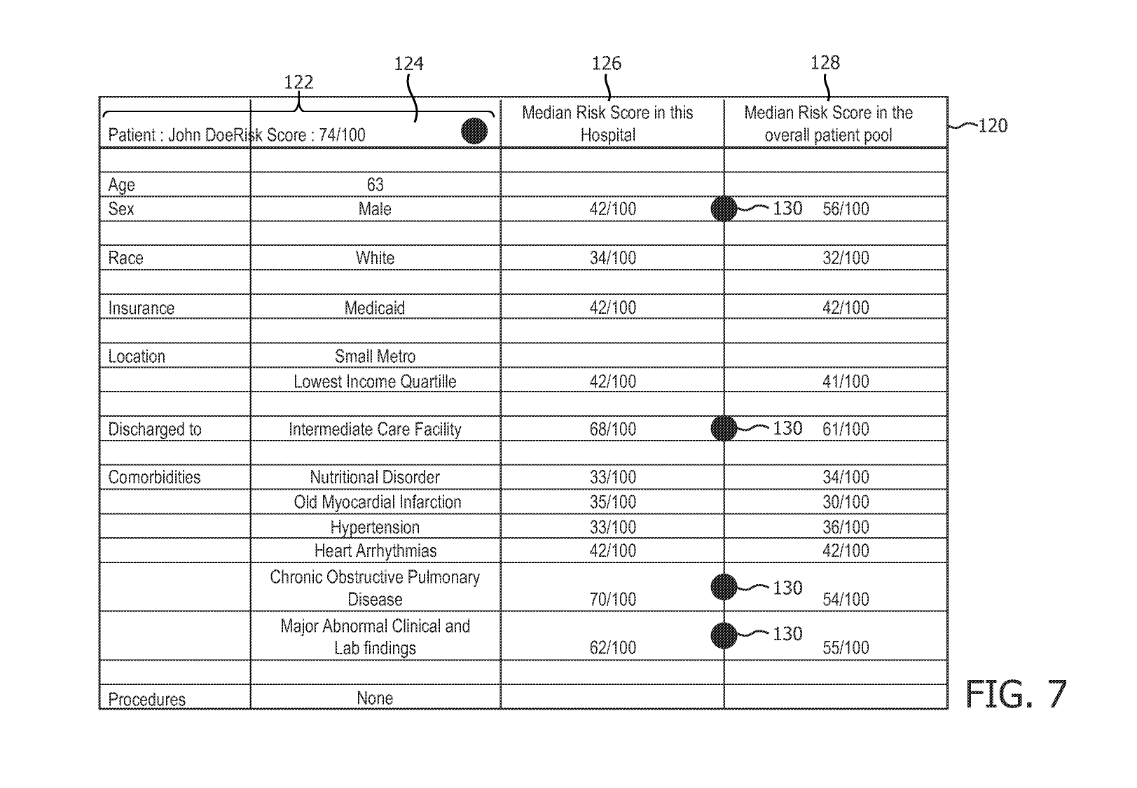

FIG. 7 diagrammatically illustrates an exemplary patient risk discharge report.

With reference to FIG. 1, an embodiment of a system modeling of patient risk factors at discharge is schematically illustrated. The system includes a modeling unit 10 which generates a plurality of tree structured classifiers based on a collection of demographic, socio-econometric, diagnoses, procedure, hospital, and logistical data elements. The collection of data elements are collected by a data collection unit 12 which can collect from any number of sources which include an electronic health record 14 such an electronic hospital record (EHR), electronic medical record (EMR), and the like, government or industry data sources which include inpatient discharge abstracts 16 such as a Healthcare Cost Utilization Project (HCUP) database, or local data 18 such as a database of a plurality of hospitals. The collection represents possible predictors of patient readmission and indicates the defined population of readmission. For example, the collection includes a variable which indicates whether a readmission for a patient however defined.

The modeling unit 10 learns patient discharge risk factors based on the tree structured classifiers and data corresponding to prior patient discharges. The learning includes partitioning the data corresponding to prior patient discharges according to the collection of demographic, socio-econometric, diagnoses, procedure, hospital, and logistical data elements. The learning can be based on a random forest algorithm. The modeling unit creates a predictive model of readmission 20 based on the learned patient discharge risk factors which scores the identified patient discharge risk factors for one or more patient discharges. The predictive model of readmission can be stored in a data store.

A hospital risk management unit 22 scores risk factors for readmission to a hospital based on the predictive model of readmission scoring the data corresponding to prior patient discharges of the hospital. The scoring can include calculating statistics of patient risk factors at discharge, e.g. median, mean, minimum, maximum, etc. The hospital risk management unit can operate with selected patient populations, e.g. one or more selected groups of hospitals and/or patient discharge populations. The hospital risk management can score identified risk factors with a selected pool of discharged patients. The scored selected pool of discharged patients can include calculated statistics. The scored selected pool of discharged patients can includes comparisons between selected groups of discharged patients, e.g. between hospitals, between a hospital and hospitals of a geopolitical entity such as a state, and the like. The hospital risk management unit 20 identifies opportunities for a strategy by the hospital.

A patient risk scoring unit 24 scores a patient for risk of readmission based on the predictive model of readmission and the patient's risk factors. A display device 26 displays the patient risk factors and scoring. The display can include scores for identified risk factors with a selected pool of discharged patients, e.g. the same hospital, and/or a geographic area. The display device 26 can be part of a workstation 28, a laptop, a smartphone, or other computing device. The display device encompasses an output device or a user interface adapted for displaying images or data. A display may output visual, audio, and or tactile data. Examples of a display include a computer monitor, a television screen, a touch screen, tactile electronic display, Electronic paper, Vector display, Flat panel display, Vacuum fluorescent display (VF), Light-emitting diode (LED) displays, Electroluminescent display (ELD), Plasma display panels (PDP), Liquid crystal display (LCD), Organic light-emitting diode displays (OLED), a projector, Head-mounted display, and the like. The workstation includes a processor 30 and one or more input devices 32. The input device 32 can be a keyboard, a mouse, a microphone, and the like.

A patient discharge management unit 34 generates a recommended discharge process based on the scored patient risk of readmission. The recommended discharge process can include send the patient home under surveillance, send the patient home without surveillance, keep the patient longer in the hospital, send the patient to a short-term nursing facility, ensure primary-care physician follow-ups and appointments before discharge, coordinate care with a pharmacist on a medical plan and educate the patient on a discharge plan, etc.

The various units 10, 12, 22, 24, 34 are suitably embodied by an electronic data processing device, such as the electronic processor or electronic processing device 30 of the workstation 28, or by a network-based server 36 computer operatively connected with the workstation 28 by a network 38, or so forth. Moreover, the disclosed modeling, data collection, scoring, and management techniques are suitably implemented using a non-transitory storage medium storing instructions (e.g., software) readable by an electronic data processing device and executable by the electronic data processing device to perform the techniques.

With reference to FIG. 2 one embodiment of modeling patient risk factors at discharge is flowcharted. The modeling patient risk factors at discharge can be divided into a method of model creation 40 and hospital implementation 42. The model creation 40 can be created offline or prior to implementation at a hospital. The hospital implementation can invoke execution of the created model at the time of potential discharge. In a step 50, patient discharge population data is collected by the data collection unit 12. The patient discharge population data can include inpatient discharge abstracts and/or local data of prior patient discharges. The data is collected from electronic sources and/or entered into the local data store. The data can include hundreds of possible predictors which include weak and strong predictors. The data can include meta data which provide automatic variable identification such as data dictionary information, XML descriptors, and the like.

In a step 52, a model is trained on the collected population data. The training can include a random forest algorithm. The model training can include interactive inputs from hospital management such as specific focus conditions or diseases and/or collections of hospitals, etc. Hospital risk factors are identified in a step 54 which can include a report or interactive process to define strategies to address risk factors. The created model can be stored in the risk prediction model data store 20.

At the time of a potential patient discharge, a patient discharge abstract can be collected in a step 60. The data can be extracted from the electronic health record 14. The extracted data includes data representing the identified hospital risk factors. In a step 62, the extracted data is applied to the created risk prediction model to compute a readmission risk score for the patient. In a step 64, the computed risk score is reported or displayed on the display device or other output device. The step can include recommended alternatives to discharge.

In a decision step 66, a healthcare practitioner evaluates the risk score and the patient for discharge. The process can keep the patient in the hospital and can include a subsequent reevaluation, or a discharge the patient. In a step 68, the patient discharge can include any one of recommended alternatives for discharge. The selected patient discharge can include a consultation between the healthcare practitioner and the discharged patient.

With reference to FIG. 3 one embodiment of modeling patient risk factors at discharge collecting patient discharge population data is flowcharted. In a step 70, one or conditions are identified which includes corresponding penalties for readmission. For example, if readmission penalties are applied independently by condition, then the conditions are modeled for each independent condition.

In a step 72, one or more hospitals are selected. The model can be modeled on a specific hospital and/or a collection of hospitals. For example, a collection of hospitals can include a referral region, or hospital with similar characteristics such as number of beds and/or patient mix. Including a larger patient population increases the robustness of the model. Including other hospitals provides the ability to compare patient readmission risks between the hospitals and the selected patient population.

Index admissions are extracted in a step 74, which includes admissions meeting qualifying criteria for input to the modeling process. For example, the criteria can include a principle discharge diagnosis which is the same as the identified condition. The criteria can include admissions which occurred within the selected hospitals. The criteria can exclude admissions which resulted in death, transfer, same day discharge, or discharges against medical advice. The criteria can be identified based on situations which do not qualify for a penalty.

All cause readmissions are identified from the index admissions in a step 76. The readmissions can be identified based on the application of the penalties. For example, if the readmission penalty applies for those readmissions within a 30 day period, then the all cause readmissions are identified as those which include readmission within a 30 day period. In a step 78, planned readmissions are excluded from the all cause readmissions. The index admissions which are also readmissions are excluded in a step 80. An admission cannot be both an index admission and a readmission which is an outcome. In a step 82, readmission outcomes for the index admissions are generated after the exclusions to create a modeled population.

With reference to FIG. 4 exemplary predictor classification decision trees 90 are diagrammatically illustrated. Ensemble training can include generating a plurality of unique decision trees that learn from the modeled population such as the random forest model. The random forest includes many decision trees that classify each patient based on a majority vote across all decision trees into risk or no risk categories. Risk is represented in each decision tree 92 as a boxed readmission, and no risk is represented as a boxed no readmission. Decision tree construction partitions the modeled population or input space X one factor at time until the partitions represent small homogenous groups spanning X. A homogeneous subset includes all elements which either belong to risk or no risk.

At each node, a random subset of factors are chosen for partitioning X, such as age, insurance, sex, disposition at discharge, comorbidity, procedure and the like. The factors are the data elements from the collection. Each partition is represented by a node with the corresponding data element or classifier. No two decision trees are alike. If T₁, T₂, . . . , Tₘ are the distinct trees of a forest and Tₖ(x) is the predicted outcome at tree k for an, then the classification of x, C(x)=mode{Tₖ (x),∀k}. For any patient xεX, let T₀₁, T₀₂, . . . , T₀ᵢ be the trees that predicts the patient as a risk for readmission and T₁₁, T₁₂, . . . , T₁ⱼ be the trees that predicts the patient as not at risk for readmission, where i+j=mTree. The Patient Risk Score=i/mTree. Not all data elements in the collection are relevant and not every factor has the same level of impact on patient risk. Suppose the hypothesis is that the patient outcome y is independent of a factor xᵢ, i.e. a null hypothesis Hₒ: y^{⊥}xᵢ. Set up an experiment in which the values of the variable xᵢ are randomly permuted and evaluate the drop in accuracy because of this permutation. By randomly permuting the values of xᵢ and keeping everything else constant, any dependence the outcome may have on xᵢ is removed. If Acc is the accuracy of the original model and Accᵢ is the accuracy after values of variable xᵢ is permuted then drop in accuracy is Acc−Accᵢ. If the drop is high the null hypothesis Hₒ is not accepted and xᵢ impacts patient risk is concluded. The magnitude of the drop in accuracy determines the level of importance xᵢ has on patient risk prediction.

The models can be evaluated using a weighted accuracy measure. Weighted Accuracy=βAcc⁺+(1−β)Acc⁻ with β between 0 and 1.

$${Acc}^{+} = \frac{True Positives}{( True Positives + False Negatives )}$$

is the prediction accuracy among risk admissions. True Positives (False Negatives) are the number of risk admissions correctly (incorrectly) predicted by the model. Similarly,

$${Acc}^{-} = \frac{True Negatives}{( True Negatives + False Positives )}$$

is the prediction accuracy among no risk admissions and True Negatives (False Negatives) are the number of no risk admissions correctly (incorrectly) predicted by the model.

FIG. 5 an exemplary hospital risk stratification is diagrammatically illustrated. For each hospital a set of factors affecting risk are identified by the hospital risk management unit 22. The hospital risk management unit 22 can interactively identify opportunities for a strategy. Priority patients groups are identified such as age, gender, and comorbidity as illustrated by elliptical nodes in the hierarchical tree structure. The risk factors from the model can be employed to further partition based on risk or stratify each priority group as indicated by rectangular boxes. At each node and each leaf, an opportunity for a strategy is identified. The strategy can include discharge instructions for each patient group. The discharge instructions can be carried forward into a patient discharge report. The identified opportunities for the hospital strategy can be organized according to the tree structured classifiers of the predictive model of readmission and displayed with the identified opportunities for the hospital strategy on the display device. The identified opportunities can be replaced by an entered strategy, which can be included in the display or report.

With reference to FIG. 6 an exemplary hospital risk strategy decision support tool display 100 is diagrammatically illustrated. The hospital risk management unit configures the display which is displayed by the display device. The display is configured to allow a healthcare practitioner, hospital administrator, and the like to select patient profiles 102, identified risk factors 104, and hospital characteristics 106. The selection can include menus, drop down boxes, radio button, check boxes, and the like. The selection can include further partitioning of risk factors 108 through sub-menus, additional drop down boxes, radio buttons, etc.

The patient profile identifies priority patient groups. The factor selection selects the risk factor or factors identified by the model. The hospital characteristics select the characteristics for comparison with the hospital, or comparison population group. The system user makes the selections. Based on the selection, statistics are calculated for the hospital (represented by a user of the system or additional selection added), and for a comparison population or hospitals with the selected characteristics. The hospital risk management unit 22 scores the patient discharges from the hospital and the selected different hospitals based on the selected patient profiles and the selected identifier risk factors using the models. The hospital risk management unit 22 calculates one or more statistics for scored risk factors, e.g. median risk score. The scored risk factors include a breakdown of each outcome. For example, a risk factor of disposition at discharge includes outcomes of home discharge, intermediate facility, and short-term hospital. The risk is scored on a scale of 0-100 where 0 is no risk of readmission, and 100 is certainty of readmission. The display device displays the statistics of each outcome for the scored risk factors for readmission to the hospital and the different identified hospitals 110 or hospitals with selected hospital characteristics for the selected patient profile.

With reference to FIG. 7 an exemplary patient risk discharge report is diagrammatically illustrated. The report generated by the patient discharge management unit 34 includes the patient risk factors and values 122 and a risk score 124 determined by the patient risk scoring unit 24. The report can comparison statistics with other patient populations such as the hospital 126 and/or other comparison patient populations 128 such as referral area, comparable hospitals, state wide, national pool, and the like. Specific risk factors which contribute to the risk can be highlighted with color and/or icons 130. The report can be used by healthcare practitioners in reviewing the discharge. The report can include discharge alternative recommendations. The report can be interactive to allow selection of the comparison populations such as described in reference to FIG. 6. The report can include corresponding strategies.

It is to be appreciated that in connection with the particular illustrative embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof. That is to say, it will be appreciated that various of the above-disclosed and other features and functions, or alternatives thereof, may be desirably combined into many other different systems or applications, and also that various presently unforeseen or unanticipated alternatives, modifications, variations or improvements therein may be subsequently made by those skilled in the art which are similarly intended to be encompassed by the following claims.

1. A medical system, comprising:
a modeling unit which generates a plurality of tree structured classifiers based on a collection of demographic, socio-econometric, diagnoses, procedure, hospital, and logistical data elements, learns patient discharge risk factors based on the plurality of tree structured classifiers and data corresponding to prior patient discharges, and creates a predictive model of readmission based on the learned patient discharge risk factors which scores the identified patient discharge risk factors for one or more patient discharges; and
a hospital risk management unit which scores risk factors for readmission to a hospital and identifies opportunities for a strategy by the hospital based on the predictive model of readmission scoring the data corresponding to prior patient discharges of the hospital; and
a display device which displays the identified opportunities for the hospital strategy organized according to the tree structured classifiers of the predictive model of readmission, and the identified opportunities for the hospital strategy indicated with each leaf node.

2. (canceled)

3. The system according to claim 1, further including:
a patient risk scoring unit which scores a patient for risk of readmission based on the predictive model of readmission and the patients risk factors; and
the display device displays the patient risk factors and scoring.

4. The system according to claim 2, wherein the display includes scores for identified risk factors with a selected pool of discharged patients.

5. The system according to claim 1, further including:
a patient discharge management unit which generates a recommended discharge process based on the scored patient risk of readmission and the recommended discharge process includes at least one of:
send the patient home under surveillance;
send the patient home without surveillance;
keep the patient longer in the hospital;
send the patient to a short-term nursing facility;
ensure primary-care physician follow-ups and appointments before discharge; and
coordinate care with a pharmacist on a medical plan, and educate the patient on a discharge plan.

6. The system according to claim 1, wherein the learning includes partitioning the data corresponding to prior patient discharges according to the collection of demographic, socio-econometric, diagnoses, procedure, hospital, and logistical data elements.

7. The system according to claim 1, wherein the learning is based on a random forest algorithm.

8. The system according to claim 1, wherein the data corresponding to prior patient discharges includes at least one of an electronic health record, at least one Healthcare Cost Utilization Project database, or a database of a plurality of hospitals.

9. The system according to claim 2, wherein the hospital risk management unit is further configured to include:
select one or more different hospitals based on one or more characteristics and select one or more patient profiles and select one or more identified risk factors;
score the one or more patient discharges from the hospital and the selected different hospitals based on the selected patient profiles and the selected identifier risk factors;
calculate one or more statistics for scored risk factors; and
wherein the display device displays the one or more statistics of the scored risk factors for readmission to the hospital and the different identified hospitals.

10. The system according to claim 9, wherein one or more statistics include each outcome of the selected one or more risk factors.

11. A method of processing medical patient information, comprising:
generating a plurality of tree structured classifiers based on a collection of demographic, socio-econometric, diagnoses, procedure, hospital, and logistical data elements;
learning patient discharge risk factors based on the plurality of tree structured classifiers and data corresponding to prior patient discharges; and
creating a predictive model of readmission which scores the identified patient discharge risk factors for one or more patient discharges based on the learned patient discharge risk factors; and
scoring risk factors for readmission to a hospital and identifying opportunities for a strategy by the hospital based on the predictive model of readmission scoring the data corresponding to prior patient discharges of the hospital; and
displaying the identified opportunities for the hospital strategy organized according to the tree structured classifiers of the predictive model of readmission, and the identified opportunities for the hospital strategy indicated with each leaf node.

12. (canceled)

13. The method according to claim 11, further including:
scoring a patient for risk of readmission based on the predictive model of readmission and the patients risk factors; and
displaying the patient risk factors and scoring.

14. The method according to claim 12, wherein displaying includes:
displaying scores for identified risk factors with a selected pool of discharged patients.

15. The method according to claim 11, further including:
generating a recommended discharge process based on the scored patient risk of readmission and the recommended discharge process includes at least one of:
sending the patient home under surveillance;
sending the patient home without surveillance;
keeping the patient longer in the hospital;
sending the patient to a short-term nursing facility;
ensuring primary-care physician follow-ups and appointments before discharge; and
coordinating care with a pharmacist on a medical plan, and educating the patient on a discharge plan.

16. The method according to claim 11, wherein learning is based on a random forest algorithm.

17. The method according to claim 12, further including:
selecting one or more different hospitals based on one or more characteristics and selecting one or more patient profiles and selecting one or more identified risk factors;
scoring the one or more patient discharges from the hospital and the selected different hospitals based on the selected patient profiles and the selected identifier risk factors;
calculating one or more statistics for scored risk factors; and
displaying the one or more statistics of the scored risk factors for readmission to the hospital and the different identified hospitals.

18. A non-transitory computer-readable storage medium carrying software which controls one or more electronic data processing devices to perform the method according to claim 11.

19. An electronic data processing device configured to perform the method according to claim 11.

20. A medical system, comprising:
a patient risk scoring unit which scores a patient for risk of readmission based on a predictive model of readmission which trains a random forest model on a collection of demographic, socio-econometric, diagnoses, procedure, hospital, and logistical data elements and data of prior patient discharges, and the predictive model identifies at least one set of risk factors from the collection predictive of the likelihood of patient readmission; and
a display device which displays the identified at least one set of risk factors from the collective scored for the patient risk of readmission.
